(19) United States
(12) Patent Application Publication
(10) Pub. No.: US 2023/0225543 A1
(43) Pub. Date: Jul. 20, 2023

(54) COOKING APPARATUS

(71) Applicant: Subina Shami, Grouville (JE)

(72) Inventor: Subina Shami, Grouville (JE)

(21) Appl. No.: 18/011,262

(22) PCT Filed: Jun. 30, 2021
(86) PCT No.: PCT/IB2021/055849

§ 371 Date: Dec. 19, 2022

(30) Foreign Application Priority Data
Jun. 30, 2020 (GB) 2010029.3

(51) Int. Cl. A47J 27/08; A47J 27/05; A47J 36/10

(52) U.S. Cl. CPC A47J 27/08; A47J 27/05; A47J 36/10

(57) ABSTRACT

A cooking vessel has a cooking chamber and a plurality of ingredient storage containers arranged to selectively dispense ingredients into the cooking chamber. Each storage container has a closure member selectively movable between an open position, in which the container is open to the cooking chamber, and a closed position in which the container is sealed from the cooking chamber. Each storage container has a rigid outer wall and a flexible inner liner. A device is provided for feeding a fluid to a position between the outer wall and the liner when the closure member is in its open position to eject the liner from the container and cause any ingredients located therein to pass from the storage container to the cooking chamber.

### FIELD OF THE INVENTION

This invention relates to a cooking apparatus and, in particular, to an automated cooker for preparing food comprising a plurality of ingredients.

### BACKGROUND OF THE INVENTION

Labour saving devices for assisting in the preparation of food are common to both home and professional kitchens. Devices such as food processors and blenders are used to prepare ingredients prior to cooking. However, the cooking process itself is conventionally undertaken manually during which the food being prepared is constantly monitored in order, for example, to check food temperature and avoid overcooking. In addition, different ingredients require different cooking times and therefore must be periodically added at different stages of the cooking process, again requiring constant monitoring and input from the chef. This requires a significant time investment and can therefore deter those who are time pressed from preparing home cooked meals. In the professional kitchen environment, constant supervision of dishes increases labour requirements and therefore increases costs.

Cooking devices have been developed to automate the process of adding ingredients to a dish during cooking and to control the cooking process.

US4,649,810 and US5,819.636 both disclose automated cookers which comprise a rotating carousel having multiple compartments for containing various ingredients. The carousel is mounted over a cooking vessel and has a fixed opening in its base positioned over a corresponding opening in the cooking vessel. Rotation of the carousel moves the various compartments over the opening causing the ingredients therein to deposit into the cooking vessel, the carousel being controlled to deposit the ingredients at pre-determined intervals during the cooking process. Such cooking devices require rotational drive mechanisms which increase the complexity, weight, size and cost of the device. Furthermore, the order in which the ingredients are delivered is limited by the direction of rotation of the carousel and the order in which the compartments are preloaded, and as a result the cooking programme may not be varied once initiated.

DE3346016 and US4,503,502 disclose cooking devices having a plurality of ingredient storage containers connected to a cooking chamber and arranged to selectively dispense ingredients into the cooking chamber. Each storage chamber has a closure member selectively movable between an open position in which the container is open to the cooking chamber and a closed position in which the container is sealed from the cooking chamber.

EP2429352 discloses a cooking vessel having a cooking chamber and a plurality of ingredient storage containers arranged to selectively dispense ingredients into the cooking chamber. Each storage container has a closure member selectively movable by an actuator between an open position in which the container is open to the cooking chamber and a closed position in which the container is sealed from the cooking chamber. The actuator comprises a plurality of push rods each being movable between a retracted position in which the closure member is closed and an extended position in which the closure member is open. Each closure member has a valve, the movement of the corresponding push rod to the extended position causing the valve to open creating a fluid pathway between the cooking chamber and the storage container for the ingress of gas into the storage chamber.

WO2016182975 discloses an automated cooking device which has a dispensing selector and a set of ingredient dispenser units each comprising an ingredient container and a dispensing gate having a hinged door. The dispensing gate includes a coupling mechanism for engagement with part of the dispensing selector. A control unit partially controls the dispensing selector.

Automated cooking devices such as those discussed above, do not provide effective arrangements for efficiently transferring the food ingredients from the storage containers to the cooking chamber.

### Statements of the Invention

According to the present invention, there is provided a cooking vessel having a cooking chamber and a plurality of ingredient storage containers arranged to selectively dispense ingredients into the cooking chamber, each storage container having a closure member selectively movable between an open position in which the container is open to the cooking chamber and a closed position in which the container is sealed from the cooking chamber, each storage container having a rigid outer wall and containing a flexible inner liner, means for feeding a fluid to a position between the outer wall and the liner when the closure member is in its open position in order to eject the liner from the container and cause any ingredients located therein to pass from the storage container to the cooking chamber.

Preferably, the cooking vessel comprises an enclosed chamber that enables cooking in a pressurised environment or under atmospheric pressure. The cooking vessel also controls temperature at a required level as is practised in, for instance, SOUS VIDE cooking. Preferably, the fluid is a gas under pressure, more preferably air under pressure.

Preferably, the flexible inner liners of the storage containers are of a soft silicone material.

Preferably, the cooking chamber and the storage containers are located within a common housing.

Preferably, the housing is provided with a hinged lid allowing access to a platform located above the cooking chamber, the platform being provided with mounting means for accommodating the storage containers.

Preferably, the hinged lid is movable between a lockable closed position and an open position into which it is magnetically biased.

Preferably the cooking vessel is provided with means for feeding fluid under pressure to a manifold which is connected to each storage container by a respective valve openable to allow fluid to enter the storage container.

Preferably, the cooking vessel is provided with a water tank and means for feeding water from the tank to the cooking chamber. More preferably, the water tank is removable from the cooking vessel.

Preferably, the water tank is magnetically held in position within a recess located in the vessel.

Preferably, the cooking vessel is provided with means for allowing steam to escape from the cooking chamber.

Preferably, the cooking chamber is provided with means for opening a vent to allow steam to escape. More preferably, a condensing pot is arranged in fluid communication with said vent. The condensing pot is desirably provided with a perforated condensing plate.

### BRIEF DESCRIPTION OF THE DRAWINGS

The accompanying drawings are as follows:

FIG. 1 is a side elevation of an embodiment of cooking apparatus in accordance with the present invention;

FIG. 2 is a front perspective view of the apparatus of FIG. 1 with its upper section in a raised position;

FIG. 3 is a rear perspective view of the apparatus of FIG. 1 with its upper section in a raised position;

FIG. 3A is a longitudinal section on the apparatus of FIG. 1 not including the ingredient pods;

FIG. 3B shows detail of the condensation collection mechanism of the apparatus of FIG. 1;

FIG. 3C is a top plan view of the condensing plate which is part of the condensation collection mechanism of the apparatus of FIG. 1;

FIG. 4 is a perspective view of a water tank which forms part of the apparatus of FIG. 1;

FIG. 4A is a perspective view of the apparatus of FIG. 1 with the water tank removed;

FIG. 5 is a side view of the hinged area of the upper section and body of the apparatus of FIG. 1;

FIG. 6 is a perspective view of one of the ingredient pods of the apparatus of FIG. 1 showing the pod closed;

FIG. 7 is a perspective view of one of the ingredient pods of the apparatus of FIG. 1 showing the pod open;

FIG. 8 is a longitudinal section of one of the ingredient pods of FIG. 1;

FIG. 9 shows the base of the apparatus of FIG. 1 including components mounted thereon;

FIG. 10 is a perspective view of the lid of the apparatus of FIG. 1 with components mounted thereon;

FIG. 11 is a top plan view of the lid of the apparatus of FIG. 1 with components mounted thereon; and

FIGS. 12A, 12B and 12C are system diagrams showing the relationships between the elements for various systems of the apparatus of FIG. 1.

### DETAILED DESCRIPTION OF THE INVENTION

The invention will now be described, by way of example only, with reference to the accompanying drawings.

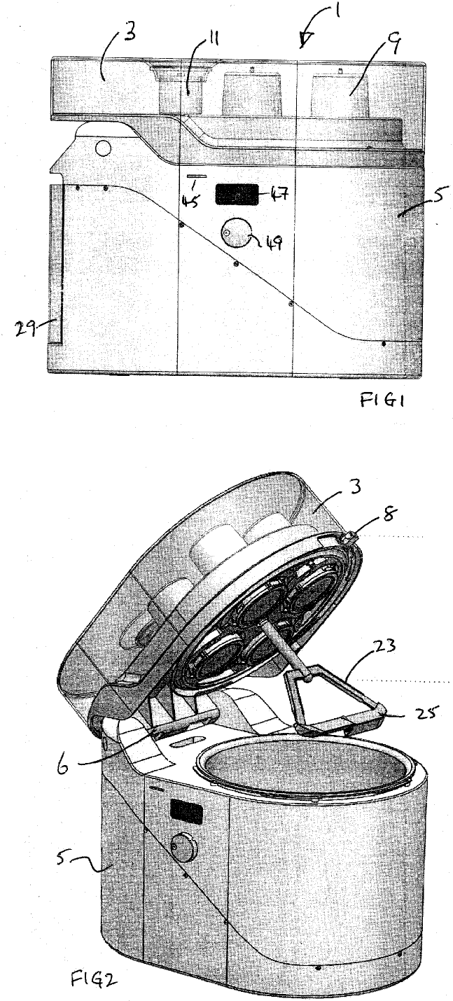

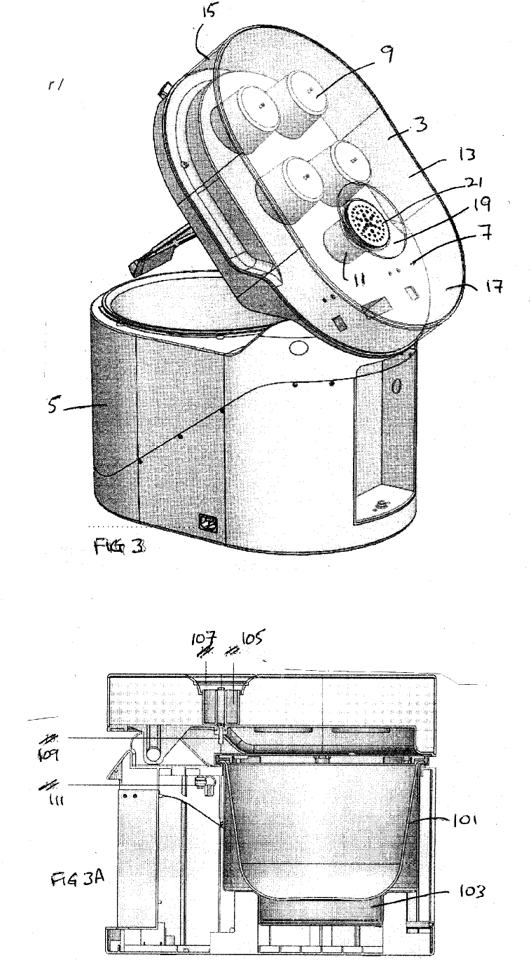

Referring to FIGS. 1 to 3 of the accompanying drawings, cooking apparatus 1 of the invention comprises an enclosed chamber that enables cooking in a pressurised environment or under atmospheric pressure. The cooking vessel also controls temperature at a required level as is practised in, for instance, SOUS VIDE cooking. The apparatus is generally oblong in plan and having a depth dimension which is between those of its length and breadth. Apparatus 1 is provided with an upper section or lid 3 which is hingedly attached to the body 5 of apparatus 1 by a hinge arrangement 6 located at one narrow end of the apparatus 1. As best seen in FIG. 5, hinge arrangement 6 is located inwardly of the end of the apparatus 1. Upper section 3 is extended beyond hinge arrangement 6 by wing 6a and the end of body 5 is shaped to provide an inclined portion 6b which, when upper section 3 is in its raised position, lies closely adjacent wing 6a. Inclined portion 6b and wing 6a are provided with magnetic elements so that the upper section 3 is maintained in position once opened.

At its opposite end, the upper section 3 and the body 5 are provided with engageable elements of a bayonet fastening including bayonet collar 8. With the upper section 3 closed, as in FIG. 1, it may be locked to the body 5 by sliding the bayonet collar 8 to the right, as viewed from the front. Unlocking is achieved by sliding the bayonet collar 8 to the left.

Upper section 3 comprises a base 7 in which are mounted four ingredient pods 9 and a condensing pot 11 which will be described in detail below. Surrounding the pods 9 and pot 11 is a transparent cover 13 which comprises a sidewall 15 and a generally flat top 17 integral therewith. Above pot 11 the top 17 has an opening with a dished margin 19, the opening accommodating a condensing plate 21.

Mounted in upper section 3 of apparatus 1 so as to extend downwardly therefrom is a stirrer 23 having a flat beater 25.

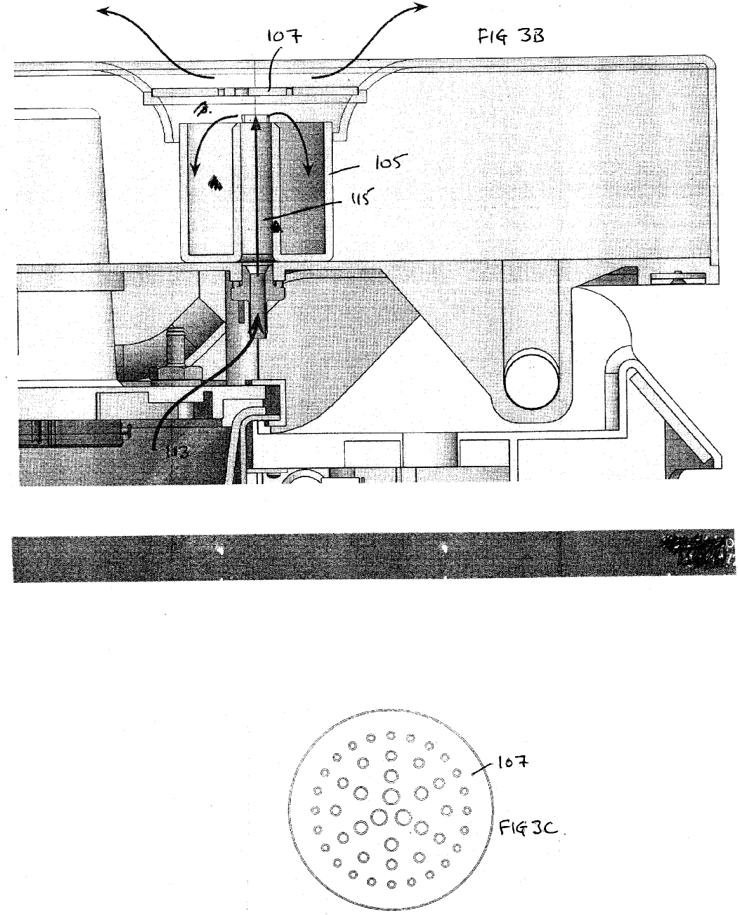

As best seen in FIG. 3A, body 5 of apparatus 1 accommodates a cooking bowl 101 which occupies a considerable proportion of the interior of body 5 below the locations of ingredient pods 9. Bowl 101 is mounted above an electric heater 103 and below a condensing pot 105 which is arranged to collect condensed water, arising from the cooking process. Above condensing pot 105 is situated a condensing plate 107 through which exhaust steam passes. A steam exhaust 109 to the surrounding atmosphere connects to a steam solenoid to output exhausted steam.

Also located within the body 5 of apparatus 1 is an air manifold 111 which is a six way manifold connecting an air motor, the exhaust and the ingredient pods as an integrated pneumatic system.

The condensation mechanism is shown in more detail in FIG. 3B. When the cooking bowl 101 is depressurised after a cooking operation, a valve at 113 is opened allowing steam to escape. The steam leaves through a vent in the lid of the cooking bowl 101 and enters the central channel 115 of the condensing pot 105. The exhausted steam hits the condensing plate 107. Some of the steam cools and condenses and is collected in the condensing pot 105. The remainder of the steam is dispersed into the surrounding atmosphere.

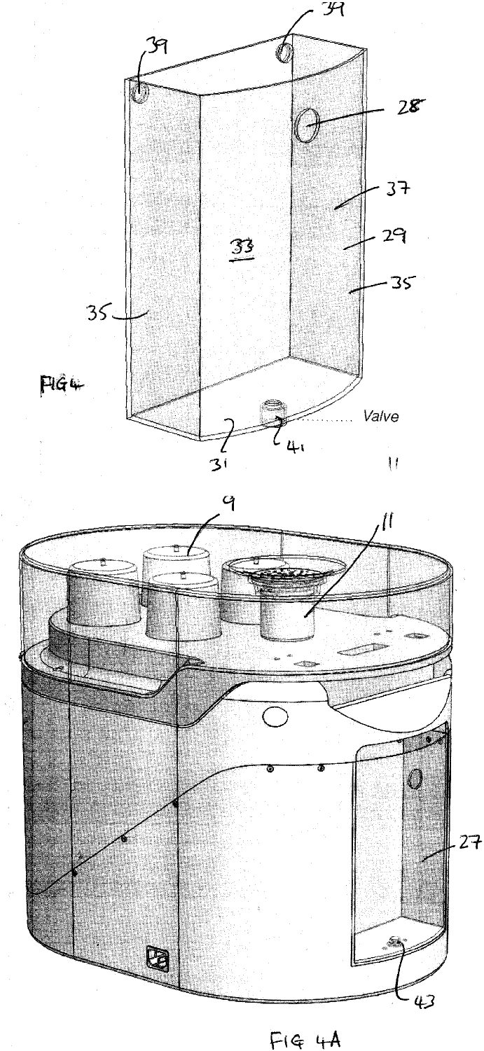

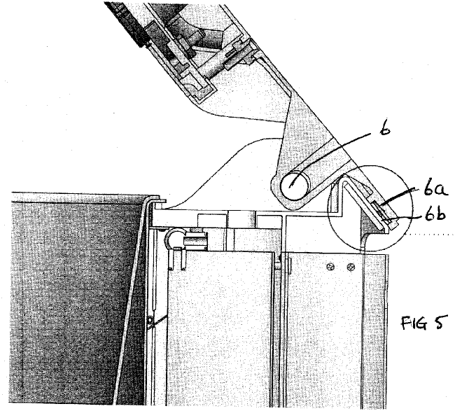

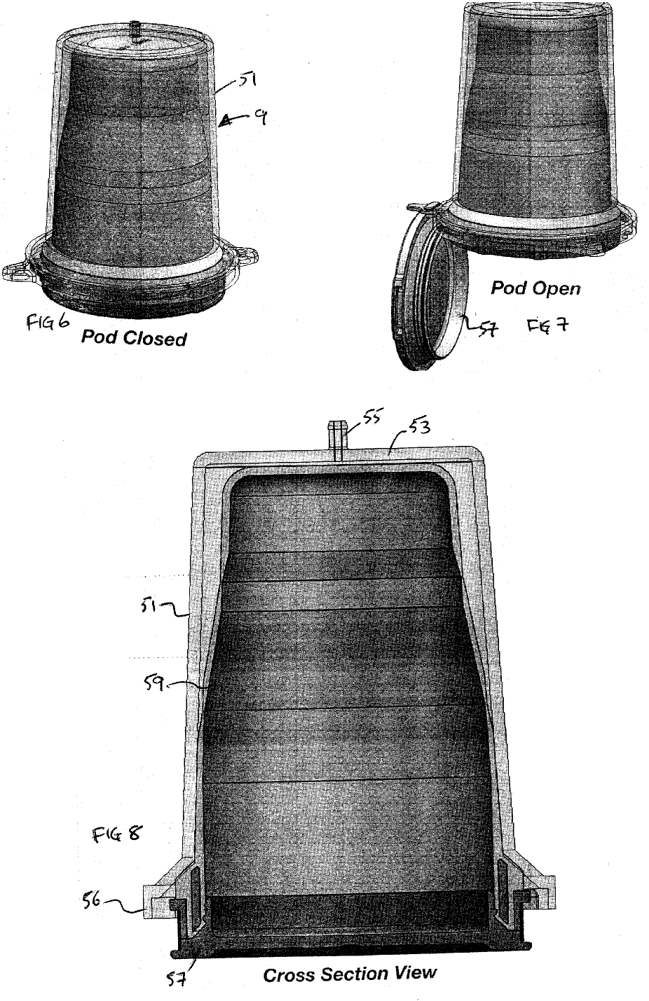

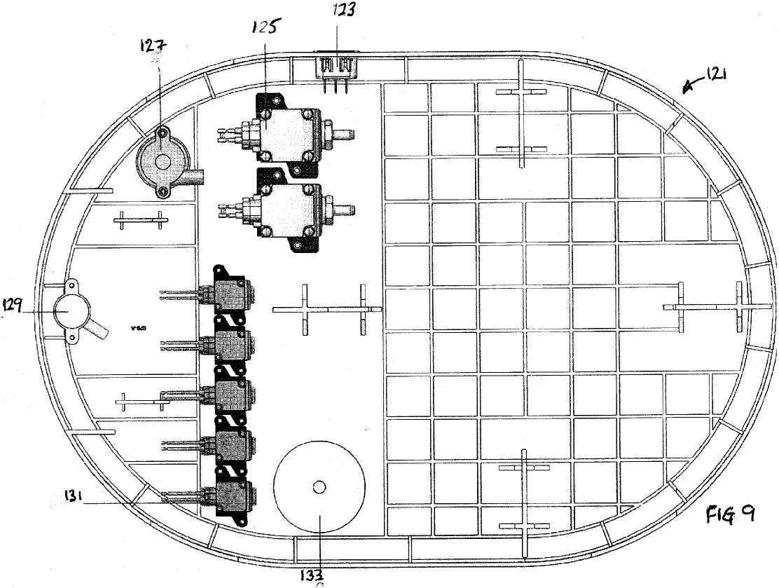

The body 5 of apparatus 1 is provided at a position below that of hinge arrangement 6 with a large cavity or recess 27 for accommodating a water tank 29 (FIG. 4). Water tank 29 includes a base 31, a rear wall 33, side walls 35 and a transparent front wall 37. It is easily manoeuvred into or out of recess 27, by inserting a finger through a hole 28 in an upper part of front wall 37, and is held within recess 27 by magnetic attraction between magnets 39 at top corners of rear wall 33 and appropriate elements (not shown) in body 5 of apparatus 1. Water tank 29 is provided with a valve 41 in its base 31, which valve makes sealing connection with water inlet 43 located centrally at the bottom of recess 27.

Body 5 of apparatus 1 is provided with a slot 45 for accommodating an SD card, a screen 47 for displaying data/information relating to the status/performance of the apparatus in operation and a control dial 49. Cooking instructions are held in the SD card and a desired recipe is selected via the control dial 49. The recipe controls the various cooking steps.

Referring to FIGS. 6 to 8 of the accompanying drawings, the ingredient pods 9 each comprise an outer inverted cup 51 made of a hard plastics material. The top 53 of cup 51 is provided with a central upwardly extending air inlet 55. At its lower end or mouth 56, cup 51 is provided with a lid 57 which is hingedly attached to the cup 51 so that it can move from the position shown in FIGS. 6 and 8 to that shown in FIG. 7. In its closed position, lid 57 makes sealing engagement with the bottom of cup 51. Accommodated within cup 51 is a soft silicone pod or liner 59 which lines the entire inner surface of cup 51 and is secured to cup 51 at its mouth 56.

Inlet 55 is connected to a motor driven air supply which, when operated, acts to feed air under pressure to the space between liner 59 and cup 51, thereby causing the liner 59 to invert, that is to say, to be expelled from within cup 51, with lid 57 being forced open in the process. Any ingredients within liner 59 are accordingly expelled from the cup 51 along with the liner although the latter remains attached to cup 51 at the mouth 56 thereof.

Referring to FIG. 9 of the accompanying drawings, the base 121 of the apparatus 1 is provided with a power port 123 by which the apparatus may be connected to an electric supply. Mounted close to power port 123 are two steam solenoid valves, one of which controls water flow into the cooking bowl 101 and the other of which controls the release of steam from cooking bowl 101.

Adjacent solenoid valves 125, there is located a water motor 127 which functions to pump water from the water tank 29 to the cooking bowl 101.

Water valve 129, situated below water tank 29, is arranged to create a seal between the water tank 29 and the interior of the apparatus 1 when the tank is in place.

An air motor 131 operates to pump air into the pneumatic system to control the inversion of the pods 9.

Also mounted on base 121 are five air solenoid valves 131 which act to control air flow from the air motor 133 to each pod 9.

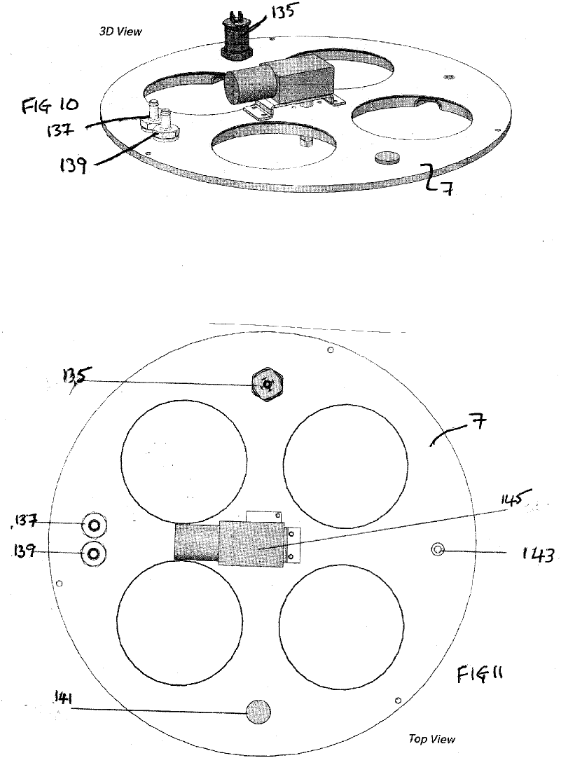

Referring to FIGS. 10 and 11 of the accompanying drawings, the base 7 of upper section 3 of the apparatus 1 has mounted thereon a pressure/temperature sensor 135. Sensor 135 measures pressure and temperature inside the cooking bowl 101 and inputs readings into the software to determine when to release the pressure solenoid valve 125.

Port 137 is a water inlet for water flowing from the water pump 127 into the cooking bowl 101. Port 139 is an outlet for steam to pass from the cooking bowl 101 to steam solenoid 125 to be exhausted to atmosphere when a pressure change is required, either when the system is to be depressurised or the pressure is to be regulated.

A safety valve 141 is a mechanical element which operates to release pressure when it exceeds a predetermined limit. A further safety valve 143 is also a mechanical element which is movable between two vertical positions. When the cooking bowl 101 is unpressurised, it sits in its lower position, allowing the collar 8 to be rotated to unlock the lid 3. When the bowl is pressurised, it rises and blocks the collar from rotating. The user is thereby prevented from opening the lid 3.

Also mounted on base 7 is a wiper motor 145 which controls the rotation of the stirrer 23.

In order to effect a cooking operation using the above-described apparatus, food ingredients are loaded into the ingredient pods 9. The hinged lid 3 is then lifted up to allow the user to insert the ingredient pods into the apparatus 1. At a predetermined time in the cooking process, air is applied to the outside of the appropriate pod 9 causing it to invert and eject its contents into the main cooking bowl 101. Water is fed from the removable water tank 29 into the cooking pot bowl 101 as required. A mechanism surrounding the steam exhaust point prevents hot steam from directly contacting the user and the perforated condensation plate 107 blocks the path of the steam allowing it to disperse while any condensates is collected in the removable cup 105.

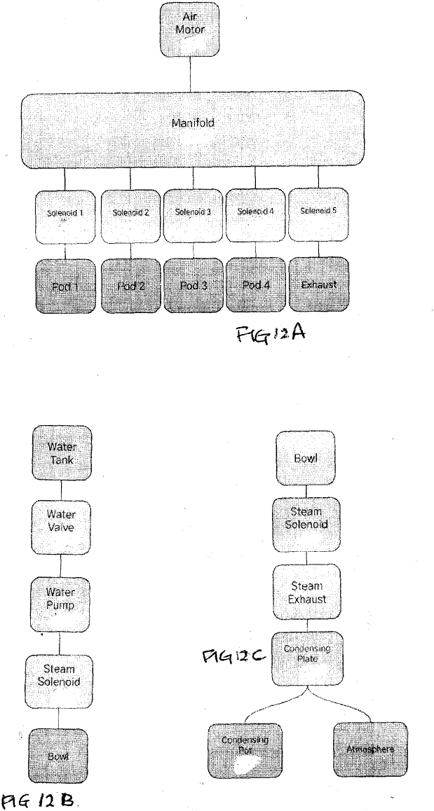

The interrelationship of the components of various aspects of the apparatus 1 are shown in FIG. 12A (the air system), 12B (the water system) and 12C (the steam system).

1. A cooking vessel comprising a cooking chamber and a plurality of ingredient storage containers arranged to selectively dispense ingredients into the cooking chamber, each storage container having a closure member selectively movable between an open position, in which the container is open to the cooking chamber, and a closed position in which the container is sealed from the cooking chamber, each storage container having a rigid outer wall and containing a flexible inner liner, means for feeding a fluid to a position between the rigid outer wall and the flexible inner liner when the closure member is in its open position for ejecting the flexible inner liner from the container and cause any ingredients located therein to pass from the storage container to the cooking chamber.

2. A cooking vessel according to claim 1, wherein the vessel comprises an enclosed chamber that enables cooking in a pressurized environment or under atmospheric pressure.

3. A cooking vessel according to claim 1, wherein the fluid is a gas under pressure.

4. A cooking vessel according to claim 3, wherein the gas under pressure is air.

5. A cooking vessel according to claim 1, wherein the flexible inner liner is made of a silicone material.

6. A cooking vessel according to claim 1, wherein the cooking chamber and the storage containers are located within a single housing.

7. A cooking vessel according to claim 6, wherein the housing has a hinged lid allowing access to a platform located above the cooking chamber, the platform having mounting means for accommodating the storage containers.

8. A cooking vessel according to claim 7, wherein the hinged lid is movable between a lockable closed position and an open position into which it is magnetically biased.

9. A cooking vessel according to claim 1, wherein the vessel includes means for feeding fluid under pressure to a manifold which is connected to each storage container by a respective valve openable to allow fluid to enter the storage container.

10. A cooking vessel according to claim 1, wherein the vessel includes a water tank and means for feeding water from the tank to the cooking chamber.

11. A cooking vessel according to claim 10, wherein the water tank is removable from the cooking vessel.

12. A cooking vessel according to claim 11, wherein the water tank is magnetically held in position within a recess located in the vessel.

13. A cooking vessel according to claim 1, wherein the cooking vessel includes means for allowing steam to escape from the cooking chamber.

14. A cooking vessel according to claim 13 wherein, wherein the cooking chamber is includes means for opening a vent to allow steam to escape.

15. A cooking vessel according to claim 14, wherein a condensing pot is in fluid communication with said vent.

16. A cooking vessel according to claim 15, wherein the condensing pot includes a perforated condensing plate.
